(19) United States
(12) Patent Application Publication
(10) Pub. No.: US 2010/0077378 A1
(43) Pub. Date: Mar. 25, 2010

(54) Virtualised Application Libraries

(75) Inventors: Brendan Maguire, Dublin (IE); Kay Muller, Dublin (IE); Mark Purcell, Kildare (IE); Alexander Tarasov, Limerick (IE); Robert V. Tucker, Dublin (IE)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, Armonk, NY (US)

(21) Appl. No.: 12/237,882

(22) Filed: Sep. 25, 2008

(51) Int. Cl. G06F 9/44; G06F 9/445

(52) U.S. Cl. 717/106; 717/171

(57) ABSTRACT

The present invention provides a method and system for virtualizing a code library. The method comprises providing a description of at least one function in said code library. The description includes properties of any parameter and of any data structure required by said function. Code for a stub library for a client computer from which a library function may be called remotely is then generated. The stub library is operable to construct, in accordance with said description, a transportable data message for calling a function of said code library, the construction including determining properties of any parameter required by said called function and obtaining the argument value referred to by any pass-by-reference parameter. Code for a skeleton library, for a host computer on which said code library is hosted, is also generated. The skeleton library is operable to invoke execution of said called function in response to receipt of said transportable data message. The stub library exactly mimics the interface of the local client libraries, allowing remote functions to be called directly without using any specific API calls. This provides simple and fast remote procedure call enablement of applications with minimum programming effort, allowing applications to benefit from the direct calling of functions on remote computers.

### FIELD OF THE INVENTION

The present invention relates to the field of data processing and in particular to library virtualisation.

### BACKGROUND OF THE INVENTION

Offloading computation onto remote computer systems is a useful way to accelerate computationally complex applications. For example, in the financial services sector, spreadsheet applications are used to evaluate options prices using computationally intensive algorithms, such as the ‘Black-Scholes’ formula, which can be accelerated significantly on specialized processors, such as the Cell Broadband Engine™ (“Cell/BE”), which is heavily optimized for numerical computing. (Cell Broadband Engine is a trademark of Sony Computer Entertainment, Inc. in the United States, other countries, or both). Offloading the calculation of such formulae onto remote high performance systems significantly improves the application performance, allowing faster response times. However, enabling the offload of calculations from the application to the remote system can be a difficult challenge.

Applications may call functions from libraries run on remote machines using a Remote Procedure Call (RPC), which is an inter-process communication technology that allows a computer program to cause a subroutine or procedure to execute in another address space (commonly on another computer on a shared network). An RPC is initiated by a client sending a request message to a known remote server in order to execute a specified procedure using supplied parameters. When a response is returned to the client the application continues along with its process.

Many computer programming languages, including C, do not have a self-describing data structure, and so the transportation of complex data structures, such as arrays, is a significant problem in RPC technologies. Given a pointer to a data structure, the language doesn't know the size or shape of the data structure. Pass-by-reference array parameters are an example of this problem. Unless the size of the array is known at compile time, then extra information must be passed to the function to indicate the size of the array. Unknown parameter sizes are a problem for remote function offload systems, since the operand data must be transferred to the remote server and unless the size of the data is known, data transfer is not possible.

Pass-by-reference operand data can also be modified within a function, or a function may allocate memory to a pointer passed as a parameter. As a result operand data may only need to be sent, retrieved, or sent and retrieved. The syntax of many programming languages does not specify how a pointer passed to a function is used inside the function, and to maximize efficiency data should only be transferred when necessary.

Many traditional RPC mechanisms deal with this by requiring the use of a specific application programming interface (API), which may specify the use of fixed size arrays or program-specific datatypes, such as use of a C struct wrapper for arrays with dynamic size. This means that in order to make use of an RPC mechanism, many applications must first be modified to comply with the requirements of the RPC API. Such modifications may require a significant investment of time and effort. As a result of the level of investment required, offloading functions to remote computers is not viable for many applications. Such RPC mechanisms also create maintenance problems since changes in the API require rewriting of client applications. In the industrial domain, this is a major barrier to offloading computation to systems optimized for particular types of processing, such as machines based on the Cell/BE processor.

The present invention aims to address these problems.

### SUMMARY OF THE INVENTION

The present invention provides a method and system for virtualizing a code library. The method comprises providing a description of at least one function in said code library. The description includes properties of any parameter and of any data structure required by said function. Code for a stub library for a client computer from which a library function may be called remotely is then generated. The stub library is operable to construct, in accordance with said description, a transportable data message for calling a function of said code library, the construction including determining properties of any parameter required by said called function and obtaining the argument value referred to by any pass-by-reference parameter. Code for a skeleton library, for a host computer on which said code library is hosted, is also generated. The skeleton library is operable to invoke execution of said called function in response to receipt of said transportable data message.

Thus, according to the present invention a description of functions in a code library, 25 including the size and transfer direction of any pass-by-reference parameters required by each function, is created and generative code techniques then use this description to generate stub libraries that exactly mimic the interface of the local machine libraries, allowing remote functions to be called directly without using any specific API calls. This provides simple and fast remote procedure call enablement of applications with minimum programming effort, allowing applications to benefit from the direct calling of functions on remote computers.

Programs on client machines are able to access functions in libraries deployed on remote machines as if the libraries were deployed locally. There is no API, as such, but rather, an automatically generated interface that is identical to the original library interface. It is therefore possible for a client program designed to use a local library, to invoke the remote library without having to make changes to the application code. The advantage with this new method is that client applications can call remote functions as defined by the functions themselves rather than as defined by an RPC interface, thus eliminating the need for costly application re-writes.

### BRIEF DESCRIPTION OF THE DRAWINGS

Preferred embodiments of the present invention will now be described by way of example only, with reference to the accompanying drawings in which:

FIG. 1 shows an example of a host computer system and a virtualisation component according to a preferred embodiment of the invention;

FIG. 2 shows the basic operation of the virtualisation component according to the preferred embodiment of the invention;

FIG. 3 shows an example of a client and host computer systems with stub and skeleton libraries created according to the preferred embodiment of the invention; and

FIG. 4 shows the process of offloading calculation of function ‘X’ by the client computer system of FIG. 3.

### DESCRIPTION OF PARTICULAR EMBODIMENTS

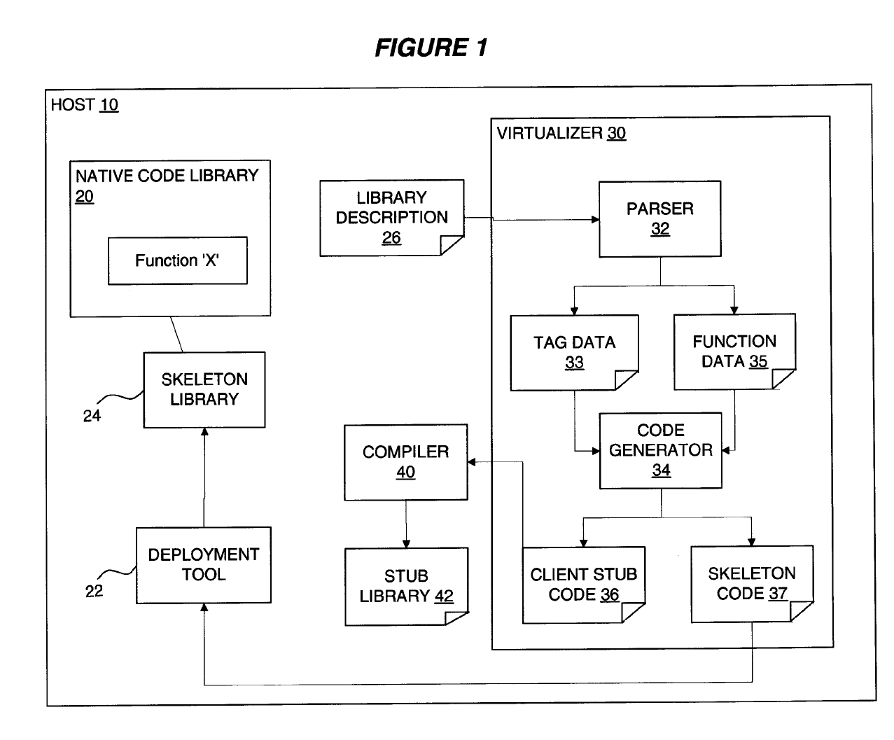

With reference to FIG. 1, the Virtualizer 30 of the preferred embodiment comprises a parser 32, code generator 34 and (optionally) a deployment tool 22. In order to enable an application to use a remote service/code library 20, a description of the functions in the code library 20 must be provided. This is typically written by the library developer. The description includes the size and transfer direction of any pass-by-reference parameters required by each function in the code library to be made available for offload using the Virtualizer. This description may be provided in the form of a library header file modified to include semantic markup in addition to the list of the prototypes of the functions that the remote library will host. A function prototype is like the signature of the function. It declares a function's interface without giving any implementation details of the function. As an example, consider the following function prototype:

int fac(int n);

This prototype specifies that in this program, there is a function named “fac” which takes a single integer argument “n” and returns an integer. Elsewhere, such as in the remote library, the function definition must be provided if one wishes to use this function. In a prototype, argument names are optional, however, the type is necessary along with all modifiers (i.e. whether it is a pointer or a const argument).

For some functions, such as those which have pointers or references as arguments, it is not clear from the function prototype what size a particular argument will have. For example, if we consider the function prototype: int fac2(int*n), unlike in the previous function, it is now not possible to determine what “int*n” actually means.

Semantic markup can be used to provide a description of the information required to invoke the remote functions. This information includes array sizes (using constants or valid C expressions to be evaluated at run-time) and transport type (including one-way/two-way data transmission). In the first example function no semantics would be required as the “int n” parameter could be handled automatically (i.e. without semantics) because it is a scalar type. In the preferred embodiment, the semantic markup comprises a set of Doxygen/JavaDoc-style Virtualizer tags. Using these tags the library developer can specify that a function is to be hosted in the remote library, and the properties, such as size and transfer direction, of any pass-by-reference parameters. Virtualizer tags can also pass other information to the Virtualizer, such as the library name or information about any structs used by the hosted function. Further details on Virtualizer tags used in the preferred embodiment of the invention, can be found in the User Guide for the IBM® Dynamic Application Virtualization (“DAV”) tool, available at www.alphaWorks.ibm.com/tech/dav, and which is incorporated herein by reference. (IBM is a trademark of International Business Machines Corporation in the United States and other countries.)

An example format for such tags is as follows:

/**IBMDAV*
* @tagType value
* @property value
* @property value
... */

There are three main tag types; library tags, function tags and struct tags. Library tags specify settings for the entire library including adding prefixes or suffixes to DAV exported functions. Function tags set properties for specifc functions, including the size and transfer direction of pass-by-reference parameters and return values. The struct tag is used to inform the virtualizer about any structs used by DAV exported functions, including the size of any pointer type struct members. Various property tags are used by the three tag types, these are shown in Table 1:

| Property Tag | Purpose | Used with |
|---|---|---|
| @library | Library name (optional, default is header file | — |
| <name> | name) | |
| @func <name> | Instruct the Virtualizer to generate stub for | — |
| | function <name> | |
| @struct | Inform the Virtualizer about struct <name> | — |
| <name> | | |
| @param[in\| | Function parameter or struct member details | @func, |
| out\|inout] | | @struct |
| <name> | | |
| @return | Use to specify size of returned data | @func |
| @dimensions | Size of a parameter or struct member | @param, |
| [<size>] | | @return |
| @ type string | Use for string type parameters | @param, |
| | | @return |
| @prefix<p>, | Prefix or suffix for DAV exported functions | @library |
| @suffix<s> | in library | |
| @lib_option” | Additional linker options for building server | @library |
| <options>” | skeleton libraries | |

The semantic markup is placed in a header file which lists prototypes of the functions that the remote library will host. For each of these functions, semantic information is provided to guide the code-generator, including the correct sizes of arrays and structures. p The preferred embodiment allows the user to transport arrays of any size. Based on the library- and function-specific Virtualizer data supplied by the library developer, the Virtualizer generates libraries that exactly mimic the interface of the local machine libraries. As a result, no application code changes are required to offload functions to remote machines using the Virtualizer. The client application need only be re-linked to the Virtualizer-generated libraries, instead of to the native code libraries.

The Virtualizer takes the description of the library 26, i.e. the modified header file, as input and uses the markup therein to generate source code for client-side stub libraries 36 and server-side skeleton libraries 37. The server-side skeleton libraries are then automatically deployed to the server/host using the deployment tool 22. The Virtualizer may call a compiler 40 to compile the source code for the client-side libraries, which are then (shown as 42) available for sharing with and installation by other users.

Let us consider the following example user library header file A:

```
/**IBMDAV*  @struct result
*  @param[out] message @dimensions [msg_length]
*/
struct result
{
      int exit_code;
      int msg_length;
      char* message;
} ;
/**IBMDAV*@function sumSquareMatrix
*  @param[in] matrix @dimensions [N*N]
*  @param[inout] r @dimensions [1]
*/
double  sumSquareMatrix(  double*  matrix,  int  N,
struct result* r);
```

Library A contains a function, called sumSquareMatrix, which accepts an N-by-N array of floating-point numbers and returns the sum of this array. This function also accepts a structure pointer that will contain relevant return information, including an error message and an exit code. The semantics state that the size of the matrix array is N-by-N and it should be transported remotely but not returned, unlike the result structure. This result structure contains an array of characters to store the error message. The size of this error message is determined by an integer inside the structure.

The following example shows an application that can use this library locally:

```
int main(int argc, char **argv)  {
    int N = 5;
    double* matrix = new double[N*N];
    for(int i=0; i<N*N; i++)
        matrix[i] = i;
    result res;
    double sum = sumSquareMatrix(matrix, N, &res);
    std::cout << “Sum of matrix is: ”
        << sum << std::endl;
    std::cout << “Exit code of function is: ”
        << res.exit_code << std::endl;
    std::cout << “Result message is: ”
        << res.message << std::endl;
    return 0;
}
```

Through use of the present invention, none of this application code will need to be modified in order to be used with a remote version of the example user library. Instead, the application just needs to link with a client-side stub library generated by the Virtualizer. The invocation of the function on the remote host will then happen automatically.

In another example, consider the function ‘calcArray’ shown below with Virtualizer tags and unknown parameter size and transfer direction. The function takes two pointers to arrays as operands, along with an integer to specify the size of the arrays:

```
/**IBMDAV* @function calcArray
* @param[in] a @dimensions [s]
* @param[inout] z @dimensions [s]
*/
double calcArray( double *a, double *z, int s ){
      double res=0;
      for (int i=0; i<size; i++){
          z[i] = a[i]*2;
          res += z[i];
      }
      return res;
}
```

Also shown above are the tags required for the Virtualizer to successfully create stub libraries for the function. The Virtualizer handles the integer parameter, s, automatically because it is a scalar type. But extra information is required for the two pointer parameters to describe the data that they point to. In this case, they are both pointers to arrays of size s. The first array, a, is input only, whilst the second, z, is both an input and an output since it is modified by the function. The @param and @dimensions tags are used to pass this information to the Virtualizer.

When run using the tag information shown in the example above the Virtualizer will produce a client-side stub library that exports a calcArray function with identical syntax to the original native code function. This function consists of code to construct the transportable data, manage calling of the remote Virtualizer function and extract the returned result data. All interactions with the underlying infrastructure are completely contained by the generated libraries, so no code changes to the client application source are required.

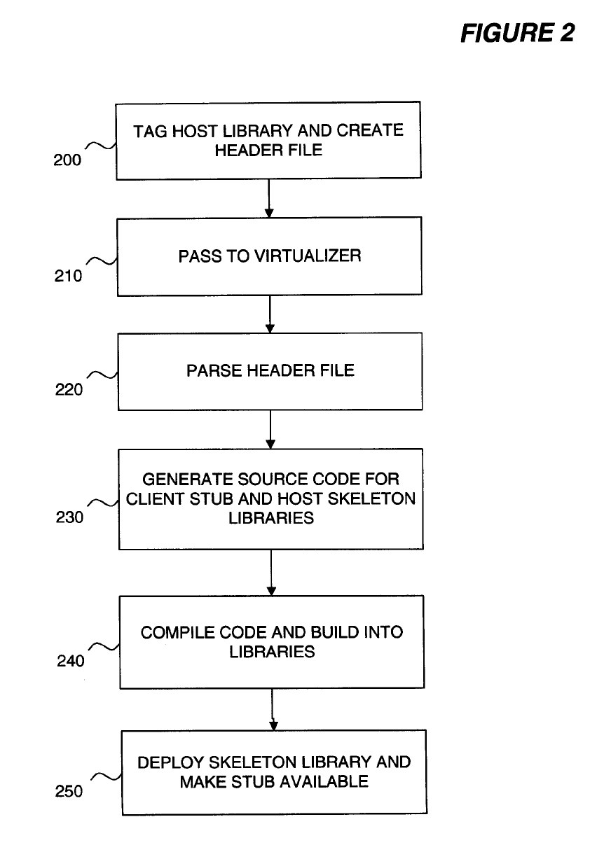

Once semantics have been created 200, the Virtualizer is called 210. Typically, the user runs the Virtualizer from the command line, passing the library header file, including Virtualizer tags as input. The basic operation of the preferred implementation is illustrated in FIG. 2. First, a syntax check on the library header file may be made to ensure the file is valid. The header file is then parsed 220 to determine the user semantics and the function prototype information. Source code for client stub and host skeleton libraries is then generated 230. This may comprise the creation of an intermediate XML (extensible Markup Language) document, which is then used to invoke a series of XSL (extensible Stylesheet Language) transformations to produce source code for the stub and skeleton libraries.

The generated code is customized based on the user semantics provided. The stub library is operable to construct a transportable data message for calling a function of said code library, which may include determining the properties of any parameter required by said called function and obtaining the argument value(s) referred to by any pass-by-reference parameter. The stub library is also able to calculate at runtime properties of any data structures required by the remote function, such as size, datatypes, and/or array dimensions. The transportable data message includes any input parameters, as well as data describing any data structures required for calling the function. Thus the stub library is able to transform a local function call into a remote procedure call to a corresponding function hosted by the code library on the host computer. The skeleton library is operable to invoke execution of the function in response to receipt of such a transportable data message and to construct a transportable data message including any output parameters returned by the function.

The generated code is also operable to transform data returned by the remote function into the original user variables for outputted function parameters.

A schema or descriptor is generated to describe the data format of the transportable data messages and this is then used by both the stub and skeleton libraries in their construction of transportable data messages for transmission to the other, as well as in their interpretation of received messages. The schema includes the transfer directions of parameters such that, for example, input-only parameters are not transmitted (or expected) in a transportable data message from the skeleton library to the stub library. From the schema information, the position of function argument data inside a data message can be determined based on the size of the argument data and the amount of data that that has been used to store the previous function arguments. In this way, it could be determined that the size of an array of data is located at a particular offset in the data message, while the array itself is located at another position in the data message and is made up of a number of bytes based on the size of the data type and the previously retrieved size.

The generated code is then compiled 240 and built into libraries using a locally available compiler. The server-side skeleton library 37 is then deployed 250 to the machine that will run the service using the deployment tool 22, and the stub library is made available to other users. As shown in FIG. 1, the Virtualizer is run on the same machine as that which hosts the native (and skeleton) library, but the Virtualizer may also be hosted remotely, as will be understood by those skilled in the art.

The libraries generated by the code generator duplicate the interface of the original native code libraries. The stub library 324 exposes the same interface as the client's local library 320, but internally, the functions invoke RPC logic to re-route a call to the remote library. The skeleton library 24 “wraps” the native library 20 on the remote host 10 and accepts the remote call from the stub library, invoking the correct function in the original library 20. These libraries thus enable client applications to call remote library functions without changing the source code for the client application 330. To access the offloaded library, the client application need only be linked to the generated client stub libraries instead of to the original native code libraries. Once the skeleton library has been deployed, the offloaded library is available for use.

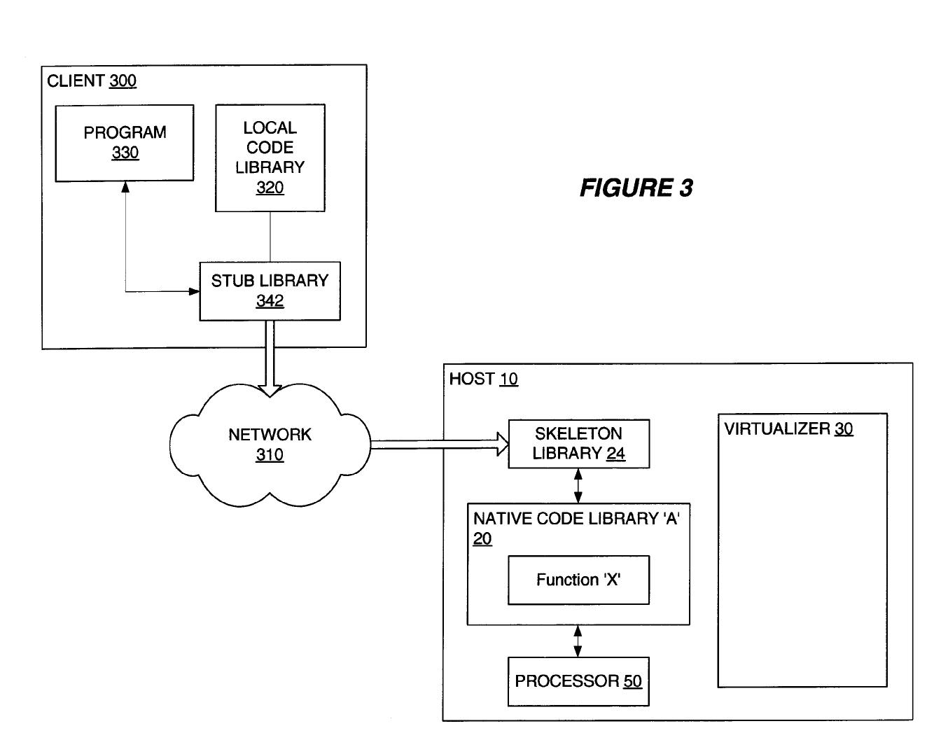

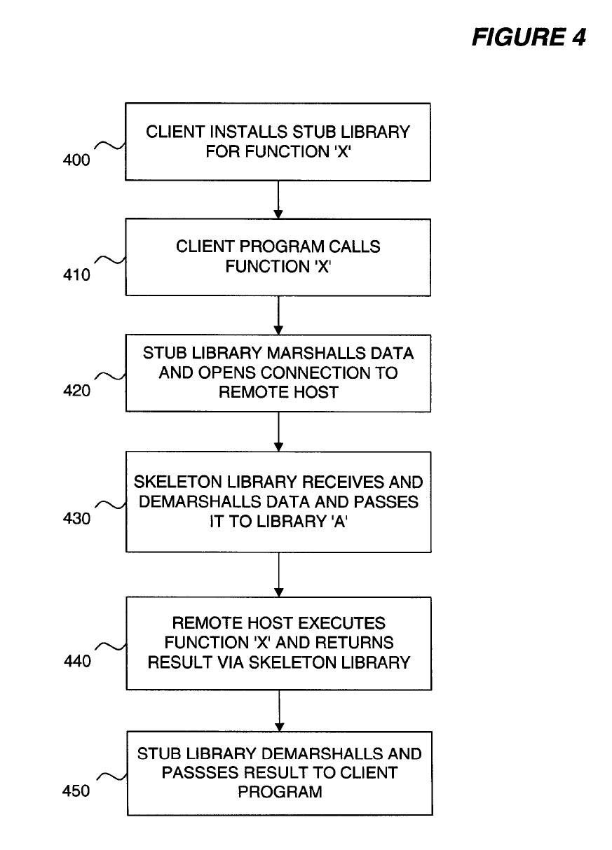

Referring to FIGS. 3 and 4, the process of offloading calculation of a function ‘X’ by a client 300 to a remote host 10 will now be described. The client 300 obtains the client stub library 42 generated previously by the Virtualizer 30, as explained above, and installs 400 this stub library 324. When a client program 330 wants the remote host to execute a function, say function ‘X’, it calls 410 the same function in its stub library 324. The stub library 324 marshalls 420 the data contained in the function call, that is constructs a transportable data message having a network-neutral data format suitable for transmission over the network 310 as a remote procedure call. During this construction, the stub library determines properties of any parameter and/or data structure required by said called function and obtains the argument value(s) referred to by any pass-by-reference parameter included in the local function call. This latter step is required because the reference or pointer of such a pass-by-reference parameter refers to an address location within the client's local memory, which will not be available to the remote host processor. So the stub library resolves the pass-by-reference parameter to determine the memory location referred to and then reads the value of the argument data stored at that location. Determining properties may include the calculation at runtime of properties such as name, size, datatype, dimension of any required arrays or structs. Thus, the stub library is able to transform a local function call into a remote procedure call to a corresponding function hosted by the code library on the host computer.

The remote procedure call is received 430 by the skeleton library 24, which demarshalls the data by transforming the data into the format required by the native code library A. The host processor 50 executes 440 function X in response to receipt of the RPC and returns the result to the skeleton library. The skeleton library marshalls the result including the calculated size of the function parameters and transforms the data into the network neutral data format for transmission back to the client program via the client stub library. The client program can then continue with its thread of execution.

The IBM DAV tool supports C, C++, Java and VBA clients and supports C/C++ server side libraries. All the standard basic types in each language are supported as well as strings, arrays, two dimensional arrays and structs. Pointers to all of these types, including pointers to arrays of up to two dimensions, are also supported. All supported types are natively supported, no DAV specific types are required, so the tool requires no client side code changes of any kind. The ability to off-load a user library without any application changes is in stark contrast to other RPC technologies, including CORBA and RPCGEN.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disc or tape, optically or magneto-optically readable memory such as compact disk (CD) or Digital Versatile Disk (DVD) etc, and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the preceding example embodiments, the invention is not limited thereto and that there are many possible variations and modifications which fall within the scope of the invention.

The scope of the present disclosure includes any novel feature or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

For the avoidance of doubt, the term “comprising”, as used herein throughout the description and claims is not to be construed as meaning “consisting only of”.

1. A method of virtualizing a code library, the method comprising:
providing a description of at least one function in said code library, said description including properties of any parameter and of any data structure required by said function;
generating code for a stub library for a client computer from which a library function may be called remotely, said stub library being operable to construct, in accordance with said description, a transportable data message for calling a function of said code library, the construction including determining properties of any parameter required by said called function and obtaining the argument value referred to by any pass-by-reference parameter; and
generating code for a skeleton library, for a host computer on which said code library is hosted, said skeleton library being operable to invoke execution of said called function in response to receipt of said transportable data message.

2. A method according to claim 1, wherein the construction includes constructing any data structure required by said called function.

3. A method according to claim 1, wherein said transportable data message includes any input parameters of the called function.

4. A method according to claim 1, wherein the skeleton library is operable, in response to receipt of a value returned by said called function, to construct a transportable data message identifying the return value.

5. A method according to claim 1, further comprising generating a schema, in accordance with said description, which describes a data format for the transportable data messages.

6. A method according to claim 1, the stub library being operable to package input parameters into a request message having a data format in accordance with the generated schema; and the skeleton library being operable to package output parameters into a response message having a data format in accordance with the generated schema.

7. A method according to claim 1, wherein the stub library is operable to transform a local function call into a remote procedure call to a function in said code library on said host computer.

8. A method according to claim 1, wherein the stub library is operable to calculate at runtime at least one property of a data structure required by said called function.

9. A method according to claim 1, wherein said properties include at least one of the following: size, array dimension, and datatype.

10. A system for virtualizing a code library, the system comprising:
means for receiving a description of at least one function in the library, said description including properties of any parameter and of any data structure required by said function;
a code generator for generating a stub library for a client computer from which a library function may be called remotely, said stub library being operable to construct, in accordance with said description, a transportable data message for calling a function of said code library, the construction including determining properties of any parameter required by said called function and obtaining the argument value referred to by any pass-by-reference parameter, and for generating a skeleton library, for a host computer on which said code library is hosted, said skeleton library being operable to invoke execution of said called function in response to receipt of said transportable data message.

11. A system according to claim 10, wherein the skeleton library is operable, in response to receipt of a value returned by said called function, to construct a transportable data message identifying the return value.

12. A system according to claim 10, wherein the code generator generates a schema, in accordance with said description, and which describes a data format for the transportable data messages.

13. A system according to claim 10, the stub library being operable to package input parameters into a request message having a data format in accordance with the generated schema; and the skeleton library being operable to package output parameters into a response message having a data format in accordance with the generated schema.

14. A system according to claim 10, wherein the stub library is operable to transform a local function call into a remote procedure call to a function in said code library on said host computer.

15. A system according to claim 10, wherein the stub library is operable to calculate at runtime at least one property of a data structure required by said called function.

16. A system according to claim 10, further comprising a deployment tool for deploying said skeleton library on said host computer.

17. A method of calling a function in a remote library from a client computer, the method comprising:
installing a stub library on said client computer, said stub library including a schema describing a data format for a transportable data message;
issuing a local library function call to the stub library; and transforming the local library function call into a remote procedure call for a corresponding function of said remote library, including determining properties of any parameter required by said corresponding function and obtaining the argument value referred to by any pass-by-reference parameter included in said local function call and constructing a transportable data message therefrom in accordance with said schema.

18. A system for calling a function in a library on a remote host computer, the system comprising:
a stub library including a schema describing a data format for a transportable data message, and being operable to receive a local function call to the stub library, and to transform the local library function call into a remote procedure call for a corresponding function of said remote library, including determining properties of any parameter required by said corresponding function and obtaining the argument value referred to by any pass-by-reference parameter included in said local function call and constructing a transportable data message therefrom in accordance with said schema.

19. A computer program product, stored on a computer readable storage medium, for virtualizing a code library and comprising computer readable program code means for performing the steps of:
providing a description of at least one function in said code library, said description including properties of any parameter and of any data structure required by said function;
generating code for a stub library for a client computer from which a library function may be called remotely, said stub library being operable to construct, in accordance with said description, a transportable data message for calling a function of said code library, the construction including determining properties of any parameter required by said called function and obtaining the argument value referred to by any pass-by-reference parameter; and
generating code for a skeleton library, for a host computer on which said code library is hosted, said skeleton library being operable to invoke execution of said called function in response to receipt of said transportable data message.
